(19) United States
(12) Patent Application Publication
(10) Pub. No.: US 2009/0254965 A1
(43) Pub. Date: Oct. 8, 2009

(54) METHOD AND SYSTEM FOR ENHANCING DISPLAY FUNCTIONALITY IN A SET-TOP ENVIRONMENT

(76) Inventors: Jason M. Smith, Bellevue, WA (US); D. David Nason, Bainbridge Island, WA (US); John A. Painter, Everett, WA (US); William J. Heaton, Everett, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/484,881

(22) Filed: Jun. 15, 2009

Related U.S. Application Data
(63) Continuation of application No. 10/167,760, filed on Jun. 12, 2002.
(60) Provisional application No. 60/297,843, filed on Jun. 12, 2001.

(51) Int. Cl. H04N 7/173

(52) U.S. Cl. 725/134

(57) ABSTRACT

Methods and systems for enhancing the storage and display of video data and other digital content in a set-top box or other television environment so that such data is securely stored and displayed are provided. Example embodiments provide an enhanced display controller (EDC) that executes in an electronic device, such as a set-top box, to provide secure storage and playback of streamed digital content. The EDC creates or identifies a secure storage location and stores the data stream in that secure location in a secure manner, thereby minimizing unauthorized access. In addition, the EDC supports the secure display of the data stream using standard (or proprietary) encryption techniques, and/or obfuscation techniques. The EDC also optionally supports various requirements for complying with the usage limitations typically associated with DRM data content. In one embodiment, the enhanced display controller is a modified set-top display (device) driver that includes a VBI decoder, mechanisms (e.g., code) for securely storing and retrieving digital content, a display obfuscation/encryption mechanism, and a secure data repository. Methods and systems for displaying dynamic, floating graphics using an EDC are also provided. These graphics may be used to as interfaces to invoke the secure storage and playback mechanisms of the EDC and to navigate through display spaces presented on the television display.

### CROSS-REFERENCE TO RELATED APPLICATIONS

This application is a continuation of U.S. patent application Ser. No. 10/167,760 filed Jun. 12, 2002 which claimed the benefit of U.S. Provisional Application No. 60/297,843, filed on Jun. 12, 2001.

### BACKGROUND OF THE INVENTION

1. Field of the Invention

The present invention relates to methods and systems for enhancing display functionality in a television set-top box environment and in particular, to methods and systems for the secure storage and display of digital data content, and the creation and display of dynamic floating navigational graphics.

2. Background Information

Set-top boxes, as commonly used with television systems (TVs), are electronic devices that provide a means for decoding and tuning digital (broadcast) signals and formatting them for display on conventional television screens. As used today, set-top boxes often provide support for both digital and analog broadcasts, as digital television has not yet completely replaced analog broadcasting. Digital broadcasting has enabled more sophisticated record and playback mechanisms above and beyond traditional approaches that use videocassette recorders (VCRs) to record TV shows on video tapes for delayed or archived playback. In particular, a television set-top box may be manufactured as a Personal Video Recorder (PVR) (example companies include TIVO and Replay TV), which allows a user to store (record) and later replay (playback) digital broadcast data as it is being transmitted to a television display. PVRs are also referred to by other terms such as digital video recorders or smart TV.

The functionality of a PVR differs from that of a VCR in that the PVR stores digital content and the PVR may be able to store more than one stream of digital content at one time (multiple simultaneous broadcasts). In addition, each stream may be separately accessed, and one stream of data may be stored while another separate stream is being received and displayed. PVRs potentially also have greater storage capacity without requiring human intervention (for example, to change tapes) and have the ability to control viewing (pause, rewind, fast-forward etc.) of a live broadcast.

Although PVR capability is commonly implemented in set-top box form, PVRs can also be implemented in a computing system that enables the display of digital broadcast content on a TV screen, such as in conjunction with a personal computer. Examples of these PVRs include advanced TV-tuner cards that are placed in such computers (e.g., ATI All-in-Wonder Radeon graphics card) and software-based solutions (e.g., Intervideo's WinDVR) which work with existing TV-tuner cards to give a PC PVR features.

Digital broadcasting and associated electronic devices have also encouraged new payment and marketing models such as pay-per-view and subscription based television viewing. Digital rights management is used in conjunction with such models to limit and define authorized use of content. Digital rights management generally refers to technology and services for automatically managing access rights to content (typically digital) via electronic means. DRM schemes protect content from unauthorized use by associating time limits (such as by duration or frequency) and authorization with particular content. For the new payment and marketing models to operate effectively, the digital rights associated with content need to be determined and followed.

### BRIEF SUMMARY OF THE INVENTION

Embodiments of the present invention provide computer-based methods and systems for enhancing the storage and display of video data and other digital content in a set-top box or other television environment so that such data is securely stored and displayed. Example embodiments provide an enhanced display controller (EDC) that executes in an electronic device, such as a set-top box or PVR, to provide secure storage and playback of digital content, such as streamed video data. The EDC creates or identifies a secure storage location on a local or networked storage device and stores the data content in that secure location in a secure manner, thereby minimizing unauthorized access. In addition, the EDC supports the secure display of the data content using standard (or proprietary) encryption techniques, and/or obfuscation techniques.

In one embodiment, a secure storage location is created from storage known only to the EDC. In one such embodiment, this storage is on a local storage device; in another embodiment this storage is on a remote storage device. In yet another embodiment, the storage is located over a network.

In another embodiment, a secure display area that is not obscured by output from other applications is allocated and used by the EDC for the secure playback of digital content. In one embodiment, a flag is inserted in the digital content to indicate secure storage requirements.

In one embodiment, the enhanced display controller is a modified set-top box display (device) driver that includes a VBI decoder, mechanisms (e.g., code) for securely storing and retrieving digital content, a display obfuscation/encryption mechanism, and a secure data repository. In some embodiments, the EDC is implemented as software code, in others, the EDC is implemented in hardware or firmware.

In one embodiment, the EDC detects digital content that is protected using Digital Rights Management (DRM) and coordinates the secure storage and playback procedures with usage limits specified by associated DRM data. Upon detection that usage limits have been exceeded, the EDC can cause a renewal process to be initiated if one is available. In addition, the EDC can destroy (e.g., erase) the data when appropriate, because the EDC controls its storage and display. In one embodiment, a flag is inserted into the digital content to indicate DRM protection. In another embodiment, the head-end or server encodes the content according to the DRM scheme, and the encoded content is automatically recognized by the EDC.

In one embodiment, the EDC implements dynamic, floating graphics on a television display. The EDC detects a request to display a floating graphic, retrieve the indicated or appropriate graphic, and causes a process associated with the graphic to be executed. In one of these embodiments the graphic is used to control storage and/or playback of digital content streams. In another embodiment, a floating graphic is used to implement a navigational tool. In one of these embodiments, a floating graphic is used to control what portion of the content is displayed in an available area on the television display. In another one of these embodiments, a floating graphic is used to control movement and manipulation of data within an alternate display area, such as that provided in U.S. Pat. No. 6,337,717, entitled “Alternate Display Content Controller,” issued on Jan. 8, 2002; and U.S. patent application Ser. No. 09/960,852, entitled “Alternate Display Content Controller,” filed on Sep. 21, 2001.

In yet another embodiment, the floating graphic is used to inform the user of priority information, such as a late-breaking news flash.

### BRIEF DESCRIPTION OF THE DRAWINGS

FIG. 1 is a block diagram of a typical set-top box environment used as a PVR with techniques of the present invention.

FIG. 2A is an example block diagram of a set-top box environment that contains an enhanced display controller that uses the enhanced security techniques of the present invention.

FIG. 2B is an example block diagram of data flow in an example enhanced display controller.

FIG. 3 is an example flow diagram of a secure storage routine of an example enhanced display controller.

FIG. 4 is an example block diagram of a video stream containing vertical blanking intervals used for security and DRM flags.

FIG. 5 is an example flow diagram of a secure playback routine of an example enhanced display controller.

FIG. 6 is an example flow diagram of DRM compatibility enhancements to an example secure storage routine of an enhanced display controller.

FIG. 7 is an example flow diagram of DRM compatibility enhancements to an example secure playback routine of an enhanced display controller.

FIGS. 8A-8C illustrate several examples of displayable floating navigational graphics.

FIG. 9 is an example illustration of display windows separated by application constructed boundaries.

### DETAILED DESCRIPTION OF THE INVENTION

### Secure Storage and Display of Digital Video Content

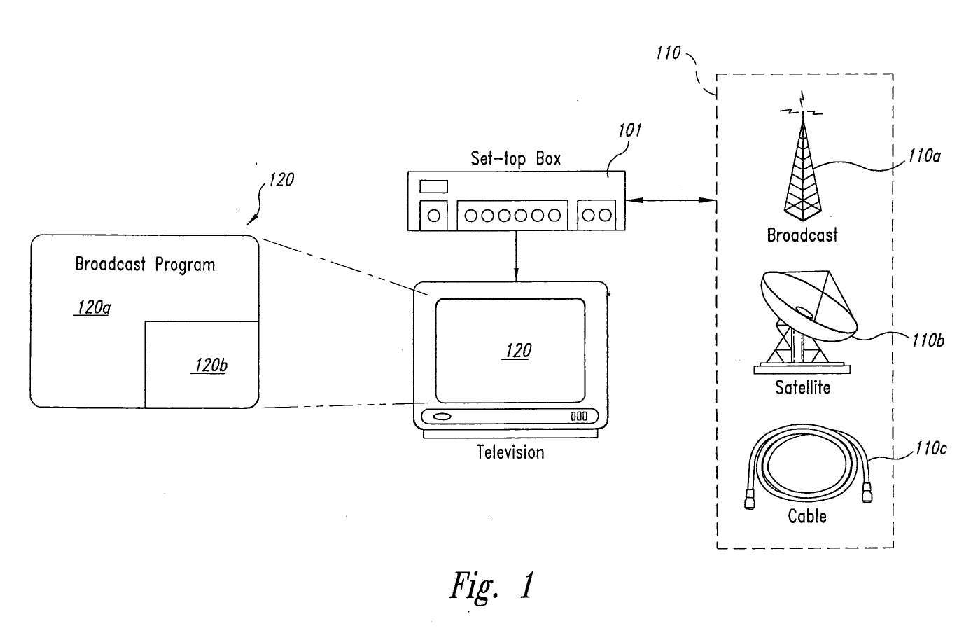

Embodiments of the present invention provide computer-based methods and systems for enhancing the storage and display of video data and other digital content in a set-top box or other television environment so that such data is securely stored and displayed. Television set-top boxes are manufactured with hardware and/or software that provide a variety of functionality, including for example, PVR capabilities that allow a user to store and later replay digital data as it is being transmitted to a television display. FIG. 1 is a block diagram of a typical set-top box environment used as a PVR with techniques of the present invention. Set-top box 101 receives input from one or more (heterogeneous or homogeneous) input sources 110, such as analog broadcast data 110A, digital data via (wireless) satellite 110B, or digital data via (wired) cable 110C, and displays such data on television display 120. The data may include a broadcast program 120A and other data, such as dynamic floating graphics (DFG) 120B, as will be discussed further below.

Using PVRs, one stream of data may be stored while another separate stream is being received and displayed, providing functionality similar to that of a videocassette recorder (VCR). In addition, multiple digital content streams may be stored at once. Also, the data stream may contain content that is legally managed under a Digital Rights Management (DRM) scheme. Current PVR implementations are not able to manage or display content pursuant to specific DRM presentation terms and conditions, because as the data is being streamed to the display, it can be intercepted by unauthorized programs or devices. In addition, when each content stream is stored, it can be intercepted Thus, there is an increasing need to manage both the secure storage and retrieval of digital data in these environments, especially in accordance with DRM requirements.

Example embodiments provide an enhanced display controller (EDC) that executes in an electronic device, such as a set-top box, to provide secure storage and playback of digital content, such as streamed video data. The EDC creates or identifies a secure storage location on a local, remote, or networked storage device and stores the data stream in that secure location in a secure manner, thereby minimizing unauthorized access. In addition, the EDC supports the secure display of the data stream using standard (or proprietary) encryption techniques, and/or obfuscation techniques, such as those described in co-owned U.S. patent application Ser. No. ______, entitled “Method and System for Maintaining Secure Data Input and Output,” filed on Jun. 10, 2002. The EDC also optionally supports various requirements for complying with the usage terms and conditions typically associated with DRM data content. Thus, unauthorized access is minimized because the EDC controls all aspects of storing the data securely, including any de-obfuscation or compliance processing, thus minimizing any transfer of data to other processes/code. In one embodiment, the enhanced display controller is a modified set-top box display (device) driver that includes a VBI decoder, mechanisms (e.g., code) for securely storing and retrieving digital content, a display obfuscation/encryption mechanism, and a secure data repository. Although discussed primarily with respect to software, one skilled in the art will recognize that embodiments of the EDC may be equivalently implemented as hardware or software.

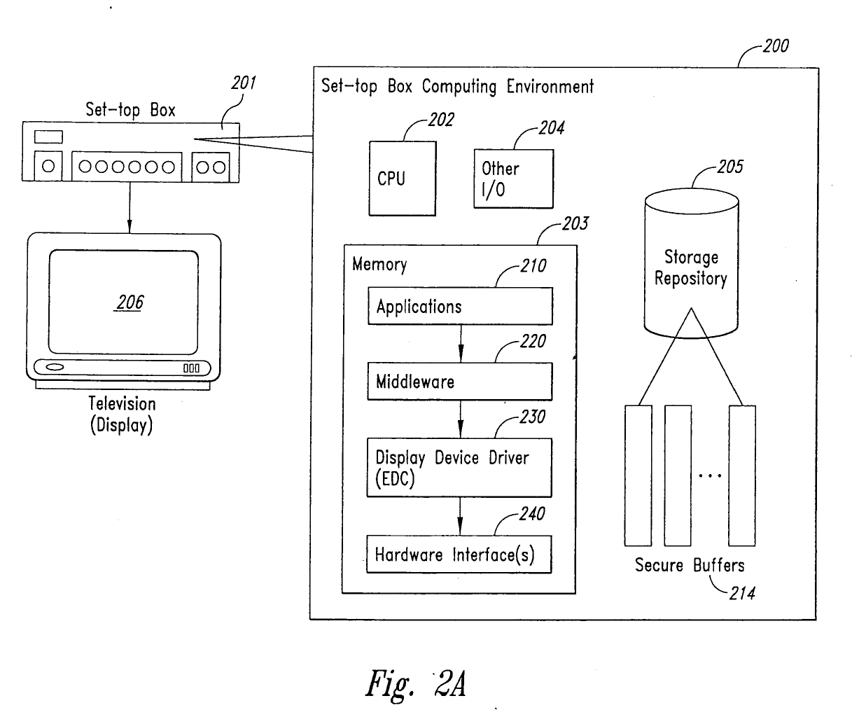

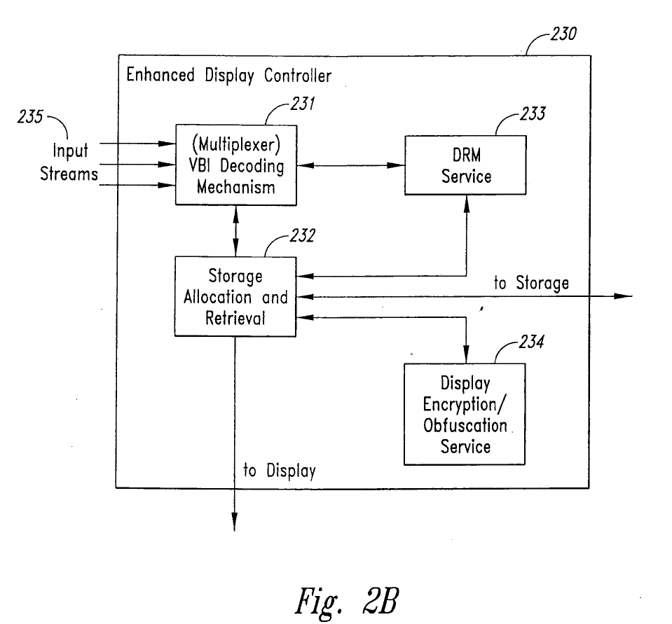

FIG. 2A is an example block diagram of a set-top box environment that contains an enhanced display controller that uses the enhanced security techniques of the present invention. In FIG. 2A, the enhanced display controller is shown as a device driver 230 executing the memory 203 in set-top box 201. The device driver 230 interacts with a persistent storage device 205 (for example, flash memory) through a storage device hardware interface 240, to store the digital content and to retrieve such content for display. The device driver 230 interacts with the television display 206 through a display hardware interface 240. The device driver 230 uses secure storage locations and secure display areas that are known only to the device driver when storing and displaying the data.

FIG. 2B is an example block diagram of dataflow in an example enhanced display controller. In typical operation, the device driver 230 decodes instructions from the input source (digital) content streams 235 coming through input sources 204, such as using VBI decoder 231 and DRM service 233, and determines whether (and what kind of) secure storage is needed. The device driver 230 then assigns, using the storage allocation and retrieval facility 232, a secure storage area (for example, secure buffer 214 in storage repository 205) to the stream and stores the data in the assigned area. When replaying the stream, the device driver 230 determines the secure storage that corresponds to the requested data and retrieves the digital content streaming it to the display 206. When obfuscation and/or encryption techniques are employed, the device driver 230 uses the display encryption and obfuscation service 234 and retrieves and applies as necessary authentication keys that are stored in a secure repository (known only to the driver 230).

One skilled in the art will recognize that the techniques of the present invention as described with reference to an example enhanced display controller are also applicable to any piece of hardware, software, or firmware that controls a persistent storage device, and also that the storage device may comprise anything capable of persistent storage. For example, the storage device may comprise a local medium such as a hard disk or flash memory, or a networked storage medium such as a personal computer, server computer, or any such data repository. Also, one skilled in the art will recognize that other steps could be implemented for each routine described below, and in different orders, and in different routines, yet still equivalently achieve the functions of the enhanced display controller.

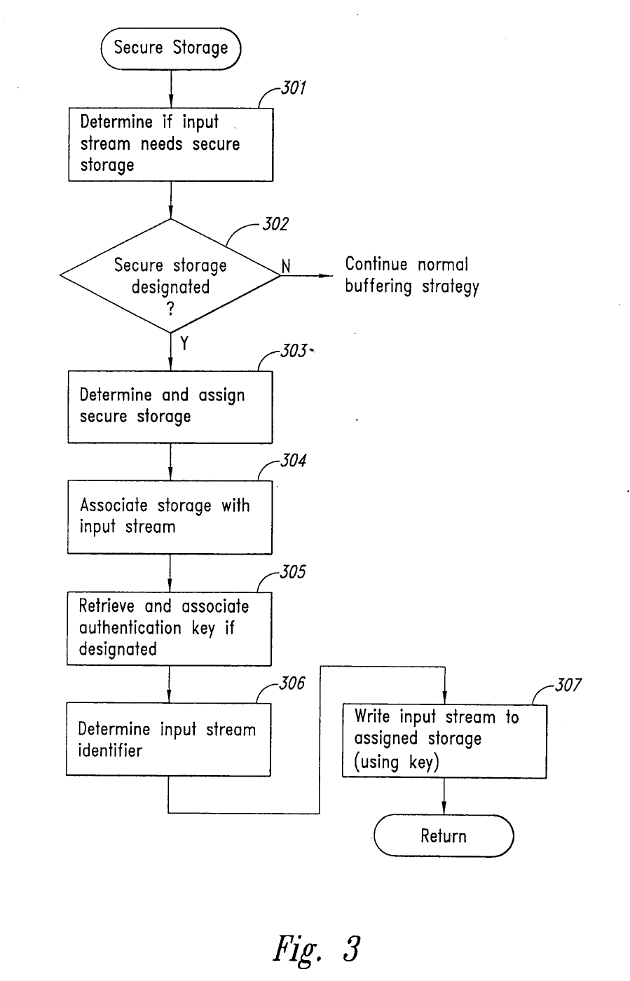

FIG. 3 is an example flow diagram of a secure storage routine of an example enhanced display controller. In step 301, the controller (EDC) determines whether the input source coming in requires or is requesting secure digital storage. One mechanism for requesting secure storage or levels of security is through the use of flags embedded in the digital content stream itself. For example, in current set-top box systems, digital content streams, such as video streams, typically include a vertical blanking interval (VBI) between each frame of data in the stream. The VBI was originally designed to overcome technical limitations in television display hardware that existed at the time. Specifically, the blanking interval was typically used to “sync” up a program that wasn't displaying properly on a particular television display. Such limitations have been since overcome with advances in digital TV technology, but the VBI standard has remained. Thus, blank intervals still exist in streamed television content and can by used by the network or head-end of a digital content stream to encode additional data to be recognized by hardware or software at the receiving end of the video stream. Existing examples of such use of data encoded within the VBI include the transmission of closed-captioning data and secondary audio program (SAP) data, such as an alternate “soundtrack” for a movie in a secondary language.

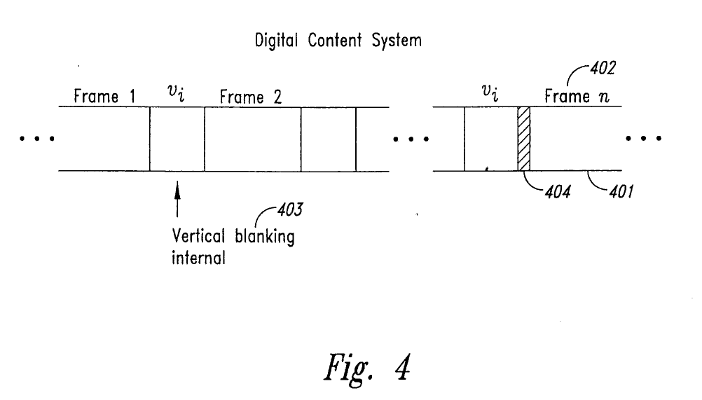

In an example embodiment of the present invention, the VBI is used to set secure storage flags at the network or head-end of the video stream, which can be decoded and recognized by the VBI decoding mechanism of the EDC to recognize a request for secure storage and, optionally, parameters associated with that request. FIG. 4 is an example block diagram of a video stream containing vertical blanking intervals used for security and DRM flags. Frames 402 of the data stream 401 are separated by an interval of time (VBIs) 403. Each VBI 403 may contain one or more flags such as secure storage flag 404.

In step 302, when the controller recognizes that the input source has designated secure storage, then in step 303 the EDC to determines and assigns a secure space, otherwise continues its normal stream buffering strategy (without secure storage). The secure space may be newly created or may be assigned from an already used pool of spaces, depending upon the storage allocation technique used. In step 304, the EDC associates the storage with the digital content stream for later retrieval. In step 305, if the instructions have indicated that an authentication key is to be used, then an appropriate authentication key is retrieved and associated with the secure storage. Depending on the flag being recognized (or, upon the receipt of specific other instructions that indicate the location of the authentication key), the key may be dynamically created, retrieved from local storage, or retrieved from an appropriate remote server. In step 306, an identifier for the digital content stream is generated or retrieved. Preferably, the name of the content is decoded from the VBI (Line 21 Field 2 EDS/XDS, or from other VBI lines determined by the head-end and the application on the display device). The identifier, the location of the secure storage space, and the authentication key may be stored external to the secure space that is associated with the content stream, and in a location known only to the display driver. Such external storage further enhances the ability for the data to be maintained securely. In step 307, the EDC writes the digital content stream to the secure storage space using the determined authentication key to encrypt or otherwise obfuscate the video stream, and then returns.

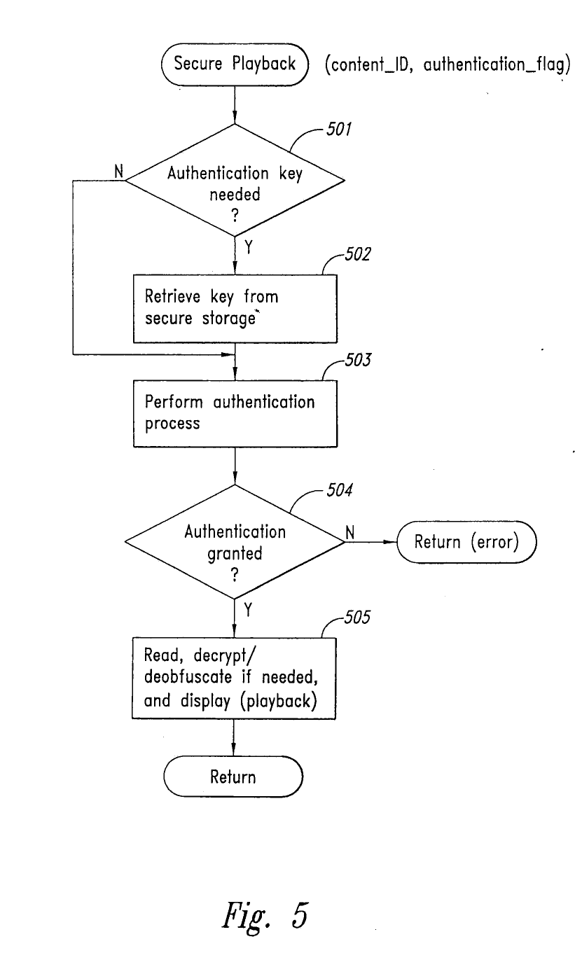

As with a typical PVR, the digital content stream can be retrieved for playback at a later time. When an authentication key is used to store the data, the same key is used to retrieve the data from the secure storage space for playback. One skilled in the art will also appreciate that, if other obfuscation techniques are employed, then these techniques are applied in reverse for playback. FIG. 5 is an example flow diagram of a secure playback routine of an example enhanced display controller. This routine is invoked by an application running on the set-top box, for example, through an application programming interface (API) call implemented by the EDC to play back previously stored content. Typically, in such a scenario, the application has access to the identifier of the stored content or the EDC implements a mechanism for mapping the content identifier to the associated secure storage location. In step 501, the enhanced display controller (EDC) determines whether an authentication key is required to decrypt or de-obfuscate the data, and if so then, continues in step 502, otherwise continues in step 503. (If authentication is not performed when there is no obfuscation or encryption used, then the controller can continue with step 505 instead.) When obfuscation or encryption techniques are available for use with playback, the application requesting obfuscated/encrypted playback preferably indicates this desire through, for example, a flag in the controller API that was used to initiate the playback. The obfuscation techniques essentially block an unauthorized program from viewing the data while it is stored prior to or during playback (display) of the data. In step 502, the routine retrieves the key from secure storage. In step 503, an authentication process may be performed. In step 504, if authentication has been granted, the routine continues in step 505, otherwise returns an error. In step 505, the content is read by the enhanced display controller from memory, obfuscated and/or encrypted if indicated, and displayed to the display device.

In another example embodiment, an enhanced display controller is provided that alters the creation of display areas on the display device itself, creating a secure display space on the display device that is unknown to the native operating system of the electronic device (e.g., personal computer, set-top box, PVR, etc.) that is controlling the display device. Once the secure display area has been created, the enhanced display controller assigns the playback of the (securely) stored digital content to the created secure display space when secure playback is requested (for example, through a playback API call). Methods and systems for creating a secure display space in this manner are described in U.S. patent application Ser. No. 09/726,202, entitled “Method and System for Controlling a complementary user interface on a Display Surface,” filed Nov. 28, 2000, and in U.S. Pat. No. 6,337,717, entitled “Alternate Display Content Controller,” issued on Jan. 8, 2002; and U.S. patent application Ser. No. 09/960,852, entitled “Alternate Display Content Controller,” filed on Sep. 21, 2001.

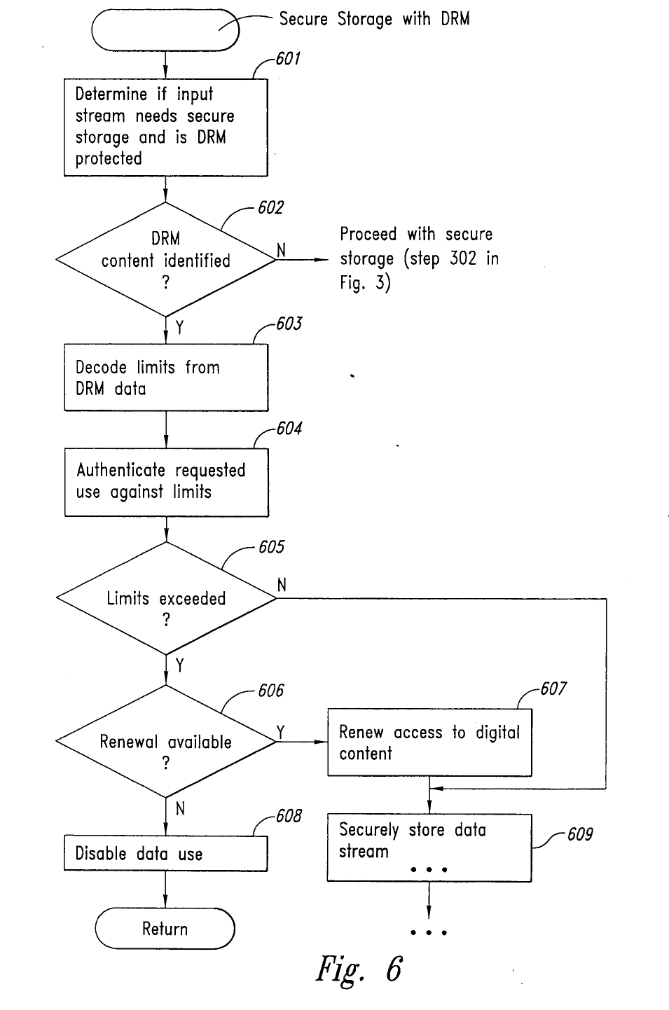

Additional enhancements are used by techniques of the present invention to support data content that is protected under Digital Rights Management (“DRM”) schemes. Data protected under DRM typically has limits (frequency or duration limits) associated with it that indicate whether a user is authorized to store or play back the data. FIG. 6 is an example flow diagram of DRM compatibility enhancements to an example secure storage routine of an enhanced display controller. In step 601, the routine determines whether the input source requires or is requesting secure storage (see FIG. 3, step 301) and whether the data is under DRM protection. One mechanism is to encode a DRM flag in an appropriate VBI of the content stream to indicate that the stream contains data that is under DRM protection. The DRM flag can be included in addition to or in place of the secure storage flags described above. The DRM flag may be set in the video stream such that it can be decoded and recognized by a VBI decoding mechanism of the EDC. Alternatively, the network or head-end may encode the entire digital content in a manner that assigns a defined flag in the content stream allowing the EDC to automatically recognize the existence of DRM content being transmitted without using the vertical blanking intervals. If, in step 602, DRM content is identified, then the routine continues in step 603, otherwise continues with the secure storage techniques described with respect to FIG. 3.

In step 603, limitation information associated with the DRM scheme is decoded from the DRM data transmitted with the content or by some mapping within the EDC. For example, information that specifies time duration or usage count limits may be associated with the DRM data. In step 604, the routine “authenticates” the requested usage, determining whether the specified limits have been exceeded. In step 605, if the limits have not been exceeded, the routine continues in step 609, else continues in step 606. In step 606, when the limits have been exceeded, the routine determines if a renewal process is available. If a renewal process is available, then in step 607 the routine preferably allows the user to renew access to the digital content. Otherwise, if the limits have been exceeded and no renewal is available, then in step 608 the EDC preferably disables the ability for the data to be used in the receiving environment. One mechanism is for the EDC to destroy its copies of the content. In step 609, once the usage request is deemed authorized, the routine continues with securely storing the input data stream as described with reference to FIG. 3.

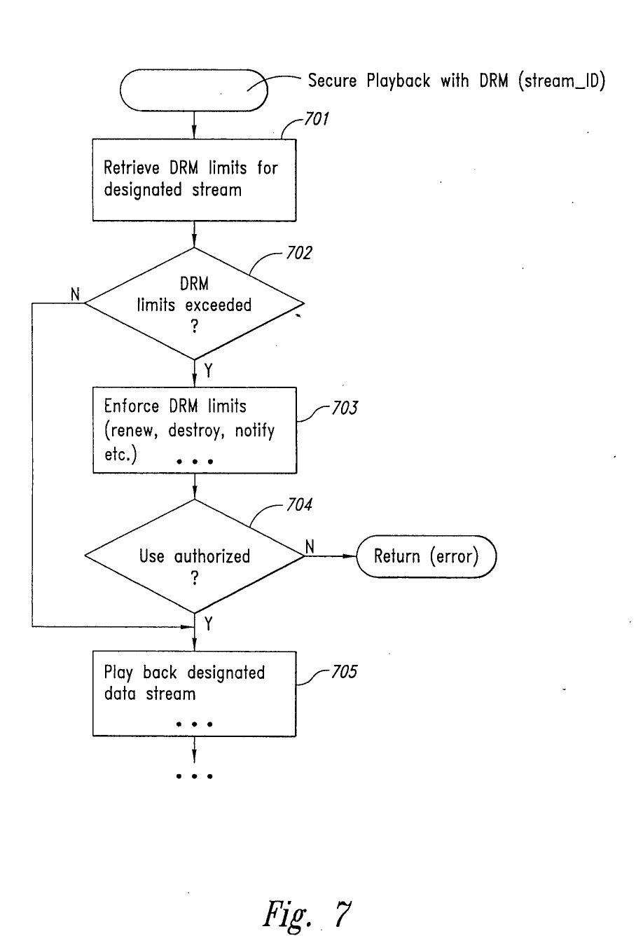

To implement DRM protected data, the EDC preferably also checks for authorized usage during the playback (and/or display) of securely stored digital content. FIG. 7 is an example flow diagram of DRM compatibility enhancements to an example secure playback routine of an enhanced display controller. In step 701, the routine retrieves the DRM duration and usage count limits associated with a particular stored stream. In an embodiment in which the network or head-end assigns the appropriate timer or counter values to the digital content stream, the EDC decodes the timer or counter values (step 602 in FIG. 6) and assigns these values to the stored content in a manner that is readable by the playback mechanism. As noted earlier, the EDC tracks the location of stored content streams in conjunction with data identifying information in order to process requests to play back the stored content. When a playback mechanism requests particular content, the EDC locates the stored stream and retrieves the DRM limit information.

In an alternate embodiment, while encoding the content stream, the network or head-end also encodes (in a particular location in the VBI, data stream, or location known to the EDC) a timer or counter “key” based on a client application request or appropriate number that the head-end can allot. The EDC upon playback decodes this “key” to retrieve the timer or counter values for the appropriate playback mechanism so that the appropriate playback mechanism, when invoked, can refer to these values during playback.

In step 702, the routine determines whether the retrieved limits have been exceeded and, if so, continues in step 703, else continues in step 705 with the with secure playback of the data stream as described with reference to FIG. 5. In step 703, the routine enforces the DRM limits.

There are several mechanisms for enforcing the DRM limits, one of which was described with reference to FIG. 6. In one embodiment, the playback application (or other playback mechanism) notifies the EDC driver (or the EDC driver detects) when the content playback time or usage count limit has been reached. Upon receipt of an indication that this limit has been reached, the controller calls a delete function to delete the content from the secure storage location. Alternatively, the playback application (or the EDC playback routine) may request a renewal or extension of time or of usage count limits, providing a renewal procedure has been specified and is available (see, for example, steps 606-608 in FIG. 6). This renewal may be accomplished for example, by obtaining input from the user or by contacting the head-end automatically, if an automatic process is defined. To achieve such functionality, as indicated during secure storage (FIG. 6), an additional flag may be included with the transmission of the digital content stream from the head-end to indicate the ability to request a renewal or extension of the time or of usage count limits. This indication is received and stored by the EDC, and the EDC indicates to the playback application that a renewal or extension request may be sent to the head-end when the indicated timer or usage count limit is reached. In addition, a user may submit a self-initiated request for renewal or extension to the playback application. The new playback time allotted in response to the request for renewal may be the same as the originally allotted time, or a new value may be sent from the head-end, decoded by the EDC playback or storage routine, and stored in a location accessible to the mechanism for playback. Variations of these techniques may also be applied to the secure storage techniques described with reference to FIG. 6, if the EDC does not attempt renewal automatically.

In step 704, if the use is authorized (the DRM limits are no longer exceeded), the routine continues in step 705 with the playback of the data stream as described with reference to FIG. 5. Otherwise, the routine returns an error.

### Dynamic Floating Graphics

As described with respect to FIG. 1, the data displayed in the television environment may include a broadcast program 120A and/or other data, such as a dynamic floating graphics (DFG) 120B. Embodiments of the present invention also provide computer-based methods and systems for displaying dynamic, floating graphics using an enhanced display controller.

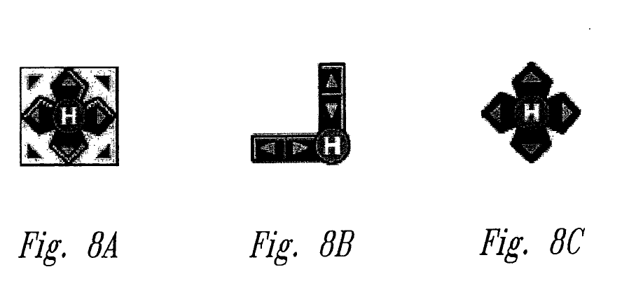

A floating graphic is, for example, any data content that is “overlayed” to float somewhere relative to an existing object being displayed. FIGS. 8A-8C illustrate several examples of displayable floating graphics. FIGS. 8A, 8B, and 8C illustrate examples of floating graphics used for navigation-floating navigational graphics. Although referred to as a “navigational” graphic, one skilled in the art will recognize that techniques of the present invention can be used to display any type of floating data, including data that is not necessarily involved or used with the process of navigating.

Upon recognition that a displayable floating graphic is being requested, the enhanced display controller retrieves and displays the designated graphic using well-known technique. Any graphical plane may be used to display the floating graphic on a television display, including the cursor graphic plane, the low-resolution graphic plane, unused high-resolution graphic plane, or the alpha channel to the display device. The display of the floating graphic does not interfere with the display of a digital content stream (e.g., a video stream). Instead, the display driver displays the graphic as an overlay on the content stream display. The floating graphic may have one or more functional processes associated with it. Once displayed, the graphic maintains the focus (e.g., cursor focus) until the graphic's associated process is ended. For example, the graphic may incorporate the functionality of a menu system, cursor, or other means of navigating through the content and applications available through the system. In one embodiment, the graphic is used to navigate content that is displayed in alternate display spaces such as those described with reference to U.S. Pat. No. 6,337,717 and U.S. patent application Ser. No. 09/960,852, which describe creation of such display spaces in a set-top box environment.

There are several ways to indicate a request to display a dynamic floating graphic including data triggered, event triggered, or user triggered. In one embodiment, the display driver decodes and recognizes a flag, e.g., encoded in the VBI of the digital content stream, that indicates an instruction to display a floating graphic. In response, the display driver displays the graphic that corresponds to the recognized flag. For example, a network may broadcast a movie or other regular program and embed a flag in the VBI of the movie transmission to indicate (to the display driver) that a particular floating graphic is to be displayed. The graphic may be useful, for example, to indicate that late breaking news is available. The user then has the ability, depending upon the functionality supported by the code (process) associated with the displayed graphic, to, for example, ignore the news feed and continue viewing the movie, start saving the movie and view the news feed, or save the news feed and continue viewing the movie.

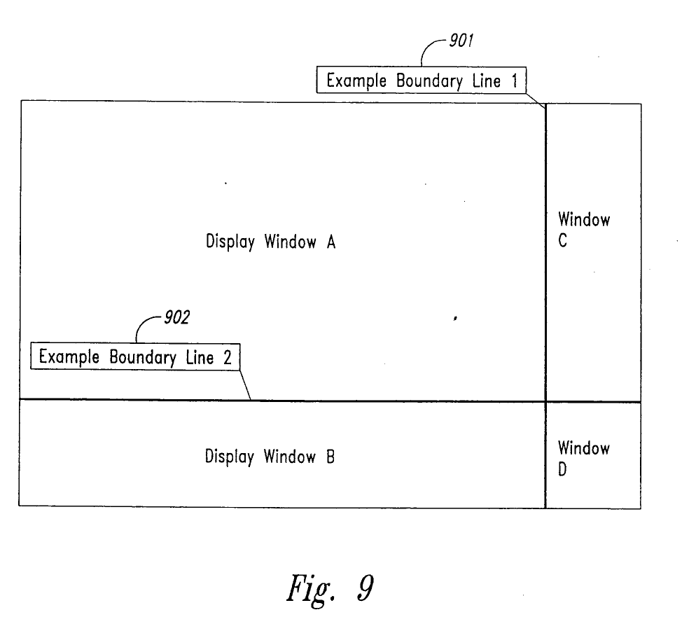

Floating graphics also may be displayed based on event triggers other than VBI encoded flags. In another embodiment, a floating graphic is displayed when a system pointer (similar to a mouse or cursor in a Windows-based computer environment) is moved over a “hot-spot” within the display area. “Hot-spots” are defined areas with pixel outlines or boundaries defined at runtime by an application or defined with consistent hard coded values, which apply to all boundary conditions and settings. FIG. 9 is an example illustration of display windows separated by application constructed boundaries. When the native cursor crosses or touches a defined pixel outline or boundary (such as boundary 901 or 902), an event is triggered, spawning a task that displays a floating graphic at the current position of the native cursor. Such a technique may be used, for example, to initiate the display of data on the display device that was not previously visible, to expand (zoom into) an area displayed within, or other similar functionality. For example, if greater content is available in one or more “directions” outside of the content currently being displayed in a display area, the floating graphic can be used to “scroll” the display area in a direction such that different content is displayed. In addition, in display areas (such as the alternate display areas mentioned above) that are not controlled by the operating system with support for cursor control, the floating graphic may be used as a floating navigational graphic to implement a type of “cursor” control.

In another example embodiment, the hotspot (or boundary) is associated with a software “callback” function, as opposed to a hardware/native cursor function. In this embodiment, when the cursor or other indication of user input crosses over into the hotspot defined are, the callback function that was previously registered (associated) with that hotspot is invoked. In this case, the callback function is used to display an associated or indicated floating (navigational) graphic. For example, each hotspot can be associated with a different callback function, or cause an identifying value to be sent to the callback function, thereby identifying which graphic to display. Such hotspots can be associated with irregular or regular shaped boundaries, as appropriate, using techniques well known in the art. Moreover, this type of hotspot with callback function invocation mechanism can be combined with other types of event triggering to integrate the use of floating graphics into general event handling for the application.

In yet another example embodiment, a floating graphic is displayed upon user request through a remote controller device signal. These signals may be of the form of an infrared signal, an RF signal, a signal from a wired control device (e.g., Sony PlayStation game controller), or other signal emitted by an input device that is recognized by the set-top box. The user input signal is interpreted by the set-top box, which determines whether the signal is a standard set-top box control signal (e.g., volume or channel change signals) or whether the signal is a pre-defined user-input signal indicating that a particular floating navigational graphic is to be displayed. For example, pressing 0-0-0-0 on an infrared remote control device may be programmed to be interpreted by the set-top box as a command to display a floating graphic allowing the user to request playback of a previously saved digital content stream as stored via the secure storage mechanisms described above.

All of the above U.S. patents, U.S. patent application publications, U.S. patent applications, foreign patents, foreign patent applications and non-patent publications referred to in this specification and/or listed in the Application Data Sheet, including but not limited to, U.S. Provisional Patent Application No. 60/297,843 filed Jun. 12, 2001, U.S. patent application Ser. No. 09/726,202 filed Nov. 28, 2000, U.S. Pat. No. 6,337,717, issued on Jan. 8, 2002; and U.S. patent application Ser. No. 09/960,852, filed on Sep. 21, 2001, and co-owned U.S. patent application Ser. No. 10/167,053, entitled “Method and System for Maintaining Secure Data Input and Output, filed Jun. 10, 2002 are incorporated herein by reference, in their entirety.

From the foregoing it will be appreciated that, although specific embodiments of the invention have been described herein for purposes of illustration, various modifications may be made without deviating from the spirit and scope of the invention. For example, one skilled in the art will recognize that the methods and systems for secure storage and display of video stream data and other digital content discussed herein are applicable to other types of storage devices and data streams, other than in a set-top box environment. For example, software or hardware on a typical desktop or networked computer system can be enhanced using these techniques to store data stream content to a secure storage area and to securely play back data stream content. One skilled in the art will also recognize that the methods and systems for displaying floating graphics discussed herein are applicable to the display of any other type of pop-up or floating text or graphic within a set-top box environment. One skilled in the art will also recognize that the floating graphics need not be navigational in nature, but may have other associated functionality, such as informational.

1. A method for security processing of a received video signal, comprising:
detecting a security control signal associated with the received video signal, the security control signal being indicative of a manner in which the received video signal should be stored;
storing the received video signal in a storage device wherein the stored video signal is secure; and
controlling access to the video signal in the storage device based on the security control signal.

2. The method of claim 1, further comprising:
processing the received video signal prior to storing in the storage device to enhance secure storage; and
retrieving the stored video signal and reverse processing of the processed video signal to thereby restore the received video signal for display on a video display.

3. The method of claim 1 for use with a set-top box, the method further comprising receiving the video signal in the set-top box wherein detecting the security control signal associated with the received video signal comprises detecting the security control signal from the video signal received by the set-top box.

4. The method of claim 1 for use with a satellite receiver, further comprising delivering a video signal detected by the satellite receiver to the set-top box wherein detecting the security control signal comprises detecting the security control signal from the video signal delivered by the satellite receiver.

5. The method of claim 1 for use with a broadcast receiver, further comprising delivering a video signal detected by the broadcast receiver to the set-top box wherein detecting the security control signal comprises detecting the security control signal from the video signal delivered by the broadcast receiver.

6. The method of claim 1 for use with a cable receiver, further comprising delivering a video signal detected by the cable receiver to the set-top box wherein detecting the security control signal comprises detecting the security control signal from the video signal delivered by the cable receiver.

7. The method of claim 1 for use with a personal computer (PC), the method further comprising receiving the video signal in the PC wherein detecting the security control signal associated with the received video signal comprises detecting the security control signal from the video signal received by the PC.

8. The method of claim 7 for use with a satellite receiver, further comprising delivering a video signal detected by the satellite receiver to the PC wherein detecting the security control signal comprises detecting the security control signal from the video signal delivered by the satellite receiver.

9. The method of claim 7 for use with a broadcast receiver, further comprising delivering a video signal detected by the broadcast receiver to the PC wherein detecting the security control signal comprises detecting the security control signal from the video signal delivered by the broadcast receiver.

10. The method of claim 7 for use with a cable receiver, further comprising delivering a video signal detected by the cable receiver to the PC wherein detecting the security control signal comprises detecting the security control signal from the video signal delivered by the cable receiver.

11. The method of claim 1 further comprising encrypting the received video signal prior to storing.

12. The method of claim 11 wherein the security control signal comprises an encryption key and detecting the security control signal comprises detecting the encryption key to encrypt the received video signal.

13. The method of claim 11 wherein the security control signal contains data related to an encryption key wherein encrypting the video signal comprises using the related data to encrypt the received video signal.

14. The method of claim 11 wherein the security control signal indicates a secure storage location in which the encryption key is stored, the method further comprising using the storage location indication to retrieve the stored encryption key.

15. The method of claim 11, further comprising retrieving the stored video signal and decrypting the video signal to thereby restore the received video signal for display on a video display.

16. The method of claim 1 further comprising obfuscating the received video signal prior to storing.

17. The method of claim 16, further comprising retrieving the stored video signal and deobfuscating the video signal to thereby restore the received video signal for display on a video display.

18. The method of claim 1 wherein the security control signal contains data indicative of digital rights management of the received video signal and storing the received video signal comprises processing the received video signal in accordance with the indicated digital rights.

19. The method of claim 18 wherein the digital rights management comprises data indicative of a predetermined number of times the received video signal may be viewed on a video display, method further comprising tracking the number of times that the video signal is viewed on the video display and disabling the video signal after the video signal has been viewed the predetermined number of times.

20. The method of claim 1 wherein storing the received video signal in a storage device wherein the stored video signal is secure comprises storing the received video signal in a storage device to prevent access by an unauthorized program or device.
